(19) United States
(12) Patent Application Publication
(10) Pub. No.: US 2009/0003763 A1
(43) Pub. Date: Jan. 1, 2009

(54) Forming a surface-mount opto-electrical subassembly (SMOSA)

(76) Inventors: Edris M. Mohammed, Hillsboro, OR (US); Ian Young, Portland, OR (US)

Correspondence Address: TROP PRUNER & HU, PC, 1616 S. VOSS ROAD, SUITE 750, HOUSTON, TX, 77057-2631, US

(21) Appl. No.: 11/823,933

(22) Filed: Jun. 29, 2007

(51) Int. Cl. G02B 6/12

(52) U.S. Cl. 385/14

(57) ABSTRACT

In one embodiment, the present invention includes an apparatus having a three-dimensional (3D) interconnect with a first cavity and a second cavity, and an integrated device formed of an electronic integrated circuit (IC) bonded to at least one optoelectronic (OE) die. The integrated device is bonded to the 3D interconnect and at least partially extends into the second cavity. Other embodiments are described and claimed.

### BACKGROUND

Optical input/output (I/O) is used in computer systems to transmit data between system components. Optical I/O is able to attain higher system bandwidth with lower electromagnetic interference than conventional I/O methods. In order to implement optical I/O, radiant energy is coupled to/from a waveguide coupled to an optoelectronic integrated circuit (IC).

One type of optical-electrical interface uses a substrate that may support a variety of electrical devices such as drivers and receivers that interface with the embedded waveguide via an optoelectronic die that in turn can be coupled to an external multi-terminal (MT) connector. These optical-electrical interfaces are generally manufactured using distinct components, which are fabricated separately, and cumbersomely assembled. Current optical-electrical interfaces generally use manual alignment techniques to obtain the necessary alignment precision. This manual aligning is used to align the optoelectronic die with the optical-electrical interface while the optical-electrical interface is stimulated and observed with a photodetector or microscope for sufficient alignment. Manual alignment does not lend itself well to high volume manufacturing (“HVM”).

Also, in current architectures electronic circuits in a driver and a receiver front-end are spatially separated from the respective optoelectronic die. Therefore, laser drivers need 50 ohm (Ω) termination to drive the optical components through a transmission line. Such termination increases power consumption significantly and can prevent a practical power efficient optical interconnect system.

### BRIEF DESCRIPTION OF THE DRAWINGS

FIGS. 1A-1D are isometric views of an interconnect structure in accordance with an embodiment of the present invention.

FIG. 2A is a front side view of an interconnect device in accordance with one embodiment of the present invention.

FIG. 2B is a backside view of the interconnect device of FIG. 2A.

FIGS. 3A-3E are process steps in accordance with one embodiment of the present invention.

FIG. 4 is a block diagram of a system in accordance with one embodiment of the present invention.

### DETAILED DESCRIPTION

In various embodiments, semiconductor opto-electronic (OE) devices and electronic integrated circuits (ICs) may be integrated on a semiconductor substrate, such as a microprocessor substrate using a precision molded surface-mount interconnect device. The resulting unit may be referred to as a surface-mount opto-electrical subassembly (SMOSA). Such assembly may be used for chip-to-chip/board-to-board optical interconnects. Using such a module, relatively low speed electrical input/output (I/O) signals from semiconductor devices such as microprocessors, chipsets or other such components may be multiplexed into high speed signals to drive opto-electronic devices (and vice versa). In various embodiments, high volume manufacturing (HVM) of such modules may be realized and the resulting modules may maximize power efficiency.

In various embodiments, a SMOSA may be formed of multiple components including, for example, a semiconductor IC such as a complementary metal oxide semiconductor (CMOS) chip, one or more semiconductor opto-electronic dies which may include optical sources such as lasers, modulators, detectors and so forth, and a three-dimensional (3D) surface mount interconnect device which may be formed using a precision molded process. In various embodiments, the electronic IC may include various circuits such as a driver for a laser such as a vertical cavity surface emitting laser (VCSEL), transimpedance amplifier, multiplexer/demultiplexers and so forth. The IC may be bonded directly onto the one or more opto-electronic dies through their respective bumps using HVM techniques such as die-to-die integration processes. The OE device includes optical sources that may be made of any light producing device, including semiconductor lasers, direct electrically modulated lasers, lasers with integrated modulators, quantum well or quantum dot devices such as VCSELs, edge emitting lasers, and the like. The OE devices may also include optical detectors that may be made of any light responsive device, including semiconductor optical detectors, such as photodiodes, and the like.

The 3D surface-mount interconnect device may have pre-fabricated alignment holes such that interconnect and bump formation may be performed with respect to these holes. Then, a solder self-alignment process may be used to provide automatic alignment of the OE dies bonded on the electronic IC with an external interconnect such as a waveguide. Using embodiments of the present invention, total power consumption may be reduced, as bump-to-bump bonding of laser driver circuits to OE dies does not need an on-die or other termination such as a 50Ω termination for the driver, as there is no transmission line between the two devices. Furthermore, HVM processing may be applied to enable automatic alignment using the pre-fabricated alignment holes. Such HVM techniques may include wafer-to-wafer or die-to-die bonding, and completed SMOSAs may be fabricated using pick and place tools to enable automatic alignment and SMOSA fabrication on a desired substrate.

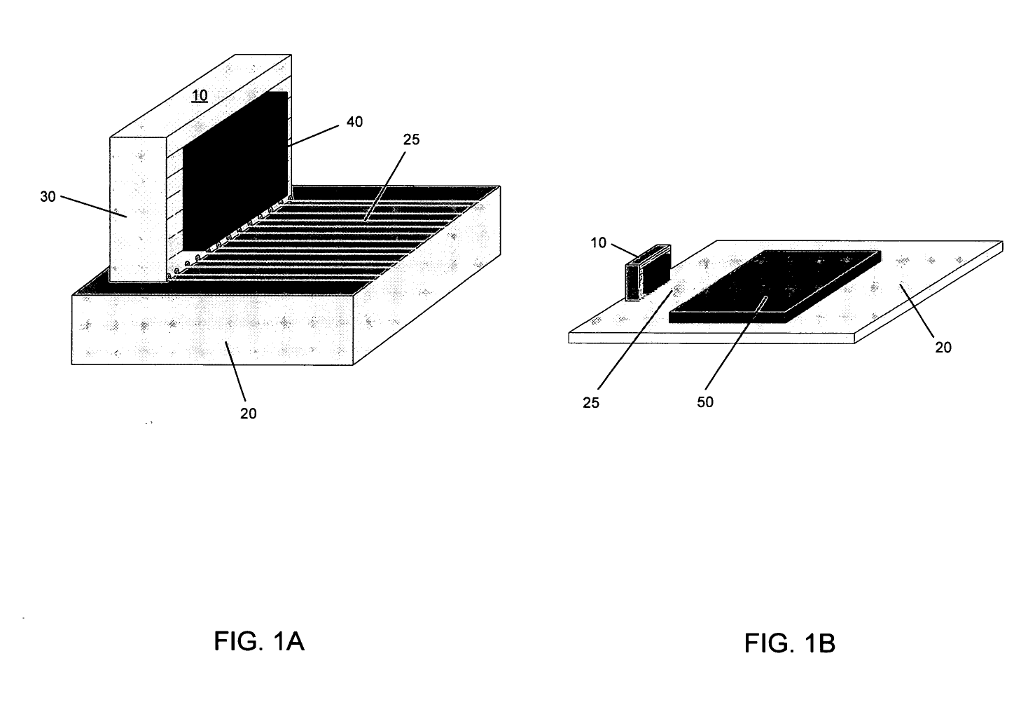

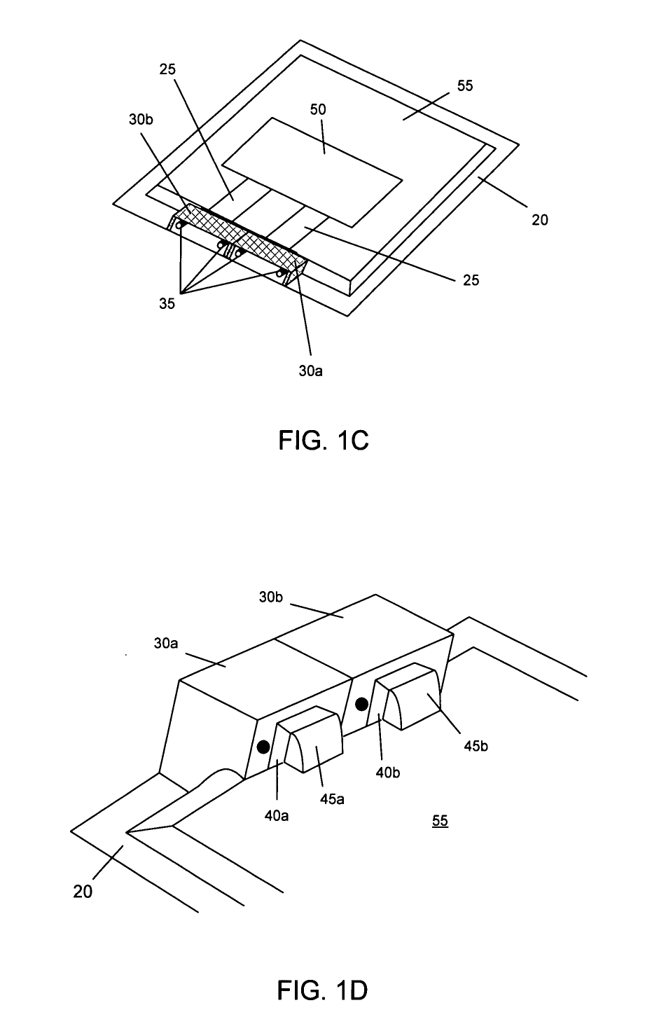

Referring now to FIGS. 1A-1D, shown are isometric views of a SMOSA in accordance with an embodiment of the present invention. As shown in FIG. 1A, SMOSA 10 may be coupled to a substrate package 20 such as a microprocessor substrate package. SMOSA 10 includes a surface mount molded interconnect device (SMMID) 30, which may be formed using a high precision molded plastic (i.e., thermoplastic) process, such as a single shot injection molding, a two-shot molding, film techniques or a combination thereof. Coupled to SMMID 30 is a bonded IC/OE device 40, which may include an electronic IC that is bonded, e.g., using solder bump technology to an OE chip array, as will be described further below. While not shown in the embodiment of FIG. 1A, optical alignment may be achieved via an opening in SMMID 30 to enable IC/OE device 40 to be solder self-aligned to later result in automatic optical alignment of the OE die of device 40 to an external optical array connector.

Also shown in FIG. 1A are a plurality of electrical traces 25 which may be used to couple the electronic IC portion of device 40 to a semiconductor device coupled to substrate package 20, such as a microprocessor. While shown as a substrate package, other embodiments may include a circuit board, motherboard, another circuit package type, and the like. Substrate package 20 may be formed of any rigid material capable of supporting conductor traces 25 and SMMID 30 thereon. For example, substrate package 20 may be made of dielectric materials, organic materials, semiconductor materials, silicon, gallium arsenide, and the like.

Referring to FIG. 1B, shown more fully is SMOSA 10 coupled via traces 25 to a semiconductor device 50 which, in one embodiment, may be a microprocessor or another such device. While shown with this simplified view in FIGS. 1A and 1B, understand that in a given package multiple SMOSAs may be provided and further components may be included to enable smooth alignment, as well as to provide support for integration into a system. Specifically, referring to FIG. 1C, shown is a more detailed view of a pair of SMOSAs 30a and 30b (generically SMOSA 30) coupled to package substrate 20. In the embodiment of FIG. 1C, SMOSA 30a may correspond to a receiver interconnect, while SMOSA 30b may correspond to a transmitter interconnect. Also shown in FIG. 1 C are alignment pins 35, two of which may be housed within each SMOSA 30. Note that alignment pins 35 may be optional and may be present either in an external connector or, as shown in FIG. 1C, within SMOSA 30. Further shown in FIG. 1C is an integrated heat spreader 55, which may be formed above package substrate 20 to provide improved heat dissipation. Note that heat spreader 55 that sits on top of package substrate 20 is shown as semi-transparent to provide a view of semiconductor device 50 and its I/O traces 25.

Referring now to FIG. 1D, shown is a more detailed view of a backside of the SMOSAs of FIG. 1C. Specifically, as shown in FIG. 1D, each SMOSA 30 may include an IC/OE device 40a and 40b (generically device 40), each of which may have a heat spreader 45a and 45b coupled thereto. Instead of heat spreaders 45a and 45b, other options to decouple the heat spreaders may be implemented based on a thermal gradient between semiconductor device 50 and the corresponding SMOSAs 30a and 30b. Thus as shown in FIGS. 1C and 1D, SMOSAs 30a and 30b may be bonded at one edge of package substrate 20 to establish optical transmission/reception to another unit (not shown in FIGS. 1C and 1D). While shown with this particular implementation in the embodiments of FIGS. 1A-1D, the scope of the present invention is not limited in this regard, and a surface mounted opto-electrical subassembly may be realized with many different configurations.

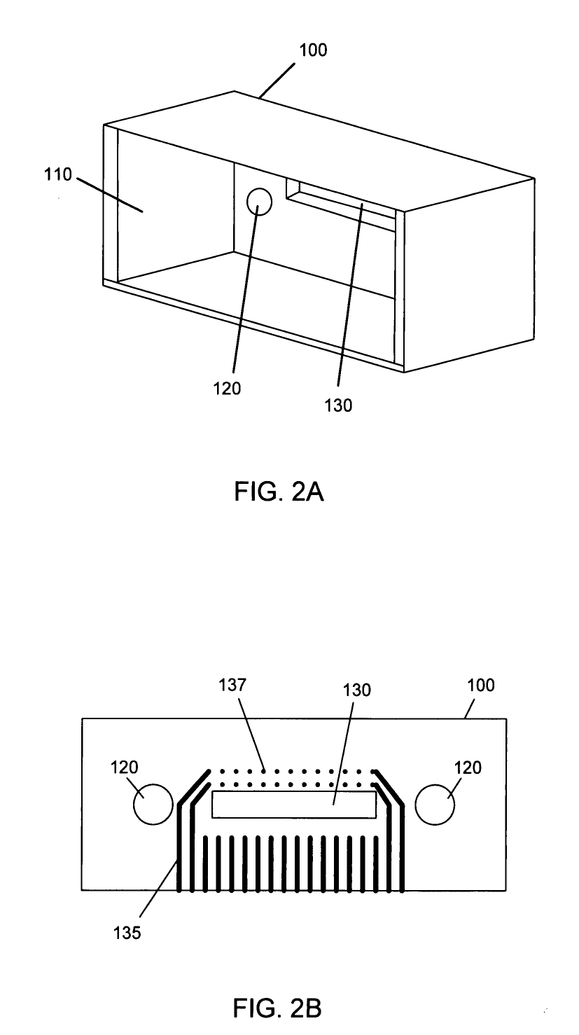

Referring now to FIG. 2A, shown is an isometric view of a front portion of an interconnect device in accordance with one embodiment of the present invention. As shown in FIG. 2A, interconnect device 100, which may be fabricated as a molded block in thermoplastic or other material, may include a first cavity 110 which may receive an external multi-terminal (MT) fiber array connector such that the connector may couple to an OE die, and more particularly to a face (e.g., an aperture face) of a VCSEL array. Also shown in FIG. 2A, although partially hidden, is a first alignment hole 120 and a second cavity 130. Second cavity 130 may be used to receive the OE portion of a combined IC/OE device, and more particularly to receive the VCSEL array. Note that in some embodiments, the combined IC/OE device may mate with interconnect device 100 such that its rear portion (i.e., having apertures of a VCSEL array) may be substantially flush with a rear wall of first cavity 110.

Referring also to FIG. 2B, shown is a backside view of interconnect device 100. As shown in FIG. 2B, alignment holes 120 may be located on either side of second cavity 130. Also present on the backside may be a plurality of interconnects 135, which may include metal lines, pads and so forth, only one of which is enumerated as such in the embodiment of FIG. 2B. Note that interconnects 135 may be spread out between solder bumps 137 (only one shown in FIG. 2B) and terminated by a solder joint at the bottom of the unit. Various manners of forming interconnects within interconnect device 100 may be realized. For example, laser direct structuring (LDS), laser subtractive structuring (LSS), or photolithography may be used to pattern desired metal interconnects, paths and so forth on the backside of interconnect device 100.

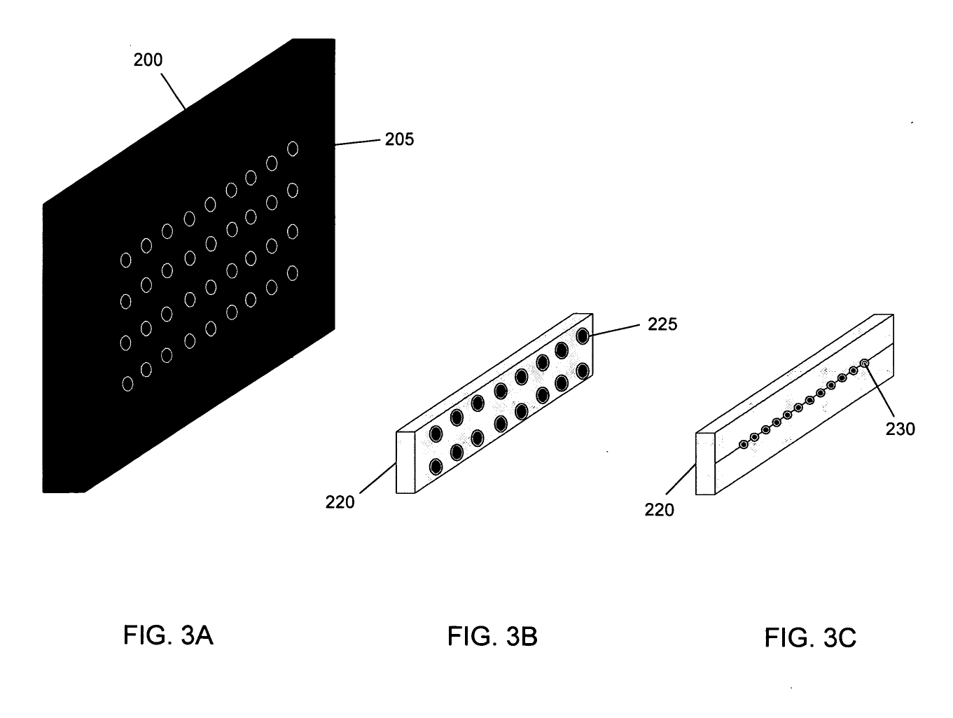

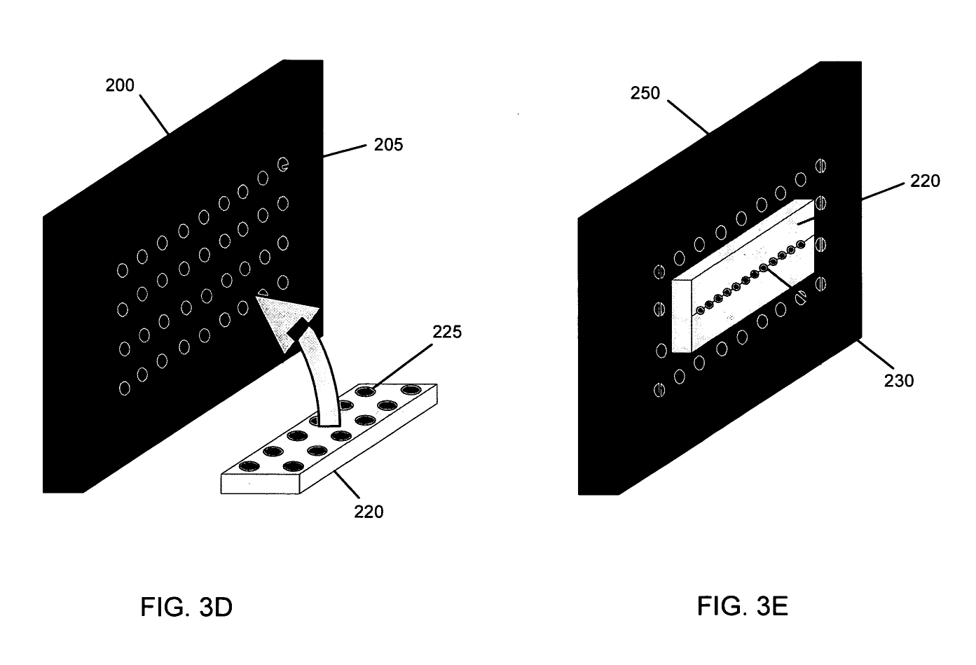

Referring now to FIGS. 3A-3E, shown are process steps used in forming a bonded IC/OE device. As shown in FIG. 3A, an IC chip 200, which may be a diced electronic IC chip, includes a plurality of solder bumps 205 on a top side thereof. These solder bumps provide connection between the circuitry of IC chip 200, which may be formed in various layers of this semiconductor device, and a corresponding OE chip and 3D interconnect. IC chip 200 may include various circuitry to handle transmission or reception of electrical data to or from another semiconductor device or other component such as a processor or so forth. In various implementations, circuitry such as may be present in a line card or other circuitry for converting parallel electrical signals into a high speed serial bit stream may be present, and vice versa. Thus when connected to an OE chip array, a direct connection between optical circuitry of the OE chip array and electrical circuitry of IC chip 200 exists.

Referring now to FIGS. 3B and 3C, shown are front and rear portions of an OE chip array 220. Specifically, as shown in FIG. 3B OE chip array 220 may be a diced OE chip array that includes a plurality of solder bumps 225 on a backside thereof, while FIG. 3C shows a front view of OE chip array 220 including a plurality of OE apertures 230. OE chip array 220 is an interface point for converting signals between the electrical and optical realms. As such, one or more optical sources and/or one or more optical detectors may be integrated within OE chip array 220. In one embodiment, OE chip array 220 is a semiconductor material, such as silicon, gallium arsenide, other Group III-V semiconductor, or the like. In one embodiment, the emitting sources may be VCELs, for example, bottom emitting VCELs having a wavelength of 990 nanometers (nm). As shown, metallization may be present on the rear side of OE chip array 220, while apertures may be present on the frontside of OE chip array 220. Then, as shown in FIGS. 3D and 3E, the OE chip may be directly bonded to the IC chip. Specifically, as shown in FIG. 3D, solder bumps 225 of OE chip array 220 may be bonded to corresponding ones of solder bumps 205 of IC chip 200 to form a completed IC/OE device 250, shown in FIG. 3E. This completed device 250 thus results in attachment of VCSEL to CMOS circuitry.

To finalize manufacture of a SMOSA, the completed IC/OE device may be bonded to a 3D interconnect device by the available solder bumps 205 and corresponding bumps on the 3D device, such as that shown in FIGS. 2A and 2B using solder self-alignment. In this way, automatic optical alignment of the OE chip to an external optical array connector may be realized. Note that a completed SMOSA may have direct current (DC) and high speed testing performed as a self-contained unit prior to the time that an HVM pick and place tool is used to bond it to corresponding solder balls on a package substrate such as that shown in FIGS. 1A-1D. Then during assembly into a system, a conventional external MT fiber or a connector may be slid into first cavity 110 of interconnect device 100 for automatic alignment of the optical arrays, e.g., VCSEL and the fiber arrays of the MT connector.

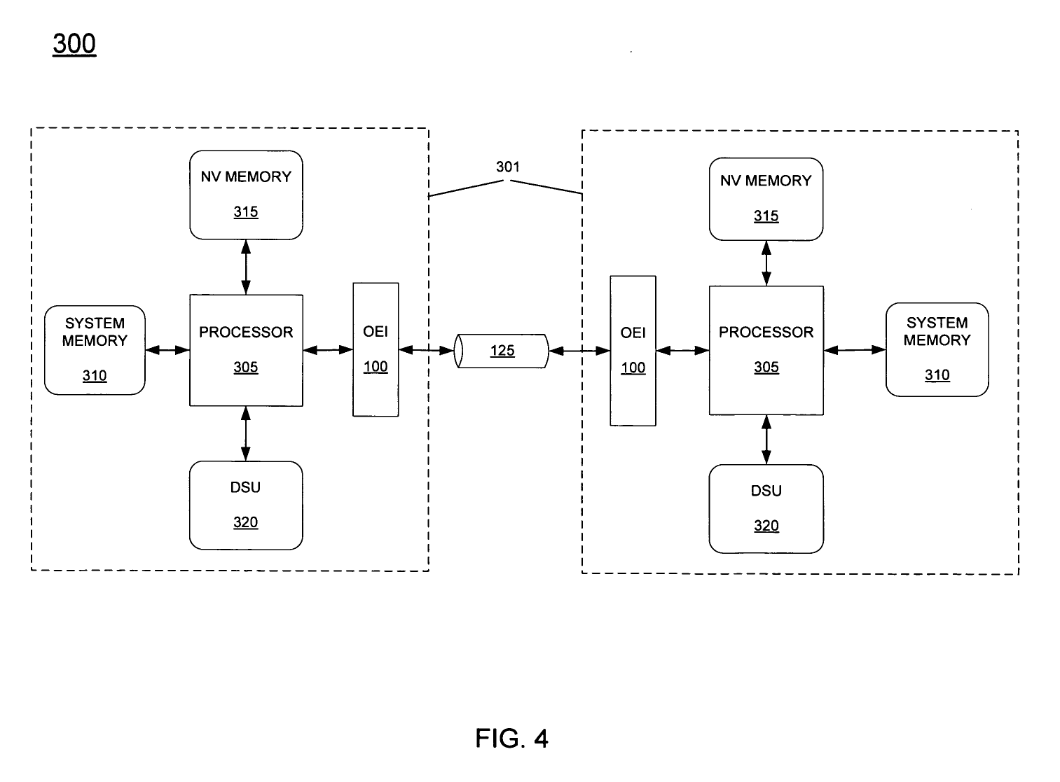

FIG. 4 is a block diagram illustrating a demonstrative system 300 in which embodiments of the invention are implemented. System 300 includes processing devices 301 communicatively coupled via an external waveguide 125 (e.g., a multi-strand fiber optic cable or the like). Processing devices 301 may represent distinct computing systems (e.g., desktop computers, notebook computers, workstations, handheld computers, servers, processing blades, or the like). Alternatively, processing devices 301 may include only a subset of the illustrated subcomponents and therefore represent circuit boards with electronic devices mounted thereon, microchips, or various other integrated circuits. In general, optoelectrical interfaces (OEIs) 100 may provide chip-to-chip, board-to-board, rack-to-rack, or system-to-system intercommunications between processing devices 301 over external waveguide 125.

The illustrated embodiments of processing devices 301 each include one or more processors (or central processing units) 305, system memory 310, nonvolatile (“NV”) memory 315, a data storage unit (“DSU”) 320, and OEI 100. Processor(s) 305 is/are communicatively coupled to system memory 310, NV memory 315, DSU 320, and OEI 100 to send and to receive instructions or data thereto/therefrom. In one embodiment, NV memory 315 is a flash memory device, although the scope of the present invention is not limited in this regard. In one embodiment, system memory 310 includes random access memory (“RAM”), such as dynamic RAM (“DRAM”), synchronous DRAM (“SDRAM”), double data rate SDRAM (“DDR SDRAM”), static RAM (“SRAM”), and the like. DSU 320 represents any storage device for software data, applications, and/or operating systems, but will most typically be a nonvolatile storage device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A system comprising:
an optoelectronic (OE) assembly having a three-dimensional (3D) interconnect including a first cavity extending into a front face thereof, a second cavity extending into a rear face thereof, and a plurality of alignment holes extending from the rear face of the 3D interconnect to the first cavity, wherein the rear face of the 3D interconnect includes a first plurality of interconnects and a second plurality of interconnects, and an integrated device having an electronic integrated circuit (IC) bonded to at least one OE die, the electronic IC of the integrated device bonded to the 3D interconnect via the first plurality of interconnects, wherein the at least one OE die extends into the second cavity;
a package substrate on which the OE assembly is coupled via the second plurality of interconnects; and
a semiconductor device coupled to the package substrate and coupled to the OE assembly by a plurality of traces of the package substrate.

2. The system of claim 1, further comprising a heat spreader coupled to a rear portion of the integrated device.

3. The system of claim 1, further comprising a plurality of alignment pins affixed within the plurality of alignment holes, the plurality of alignment pins to mate with a multi-terminal connector.

4. The system of claim 1, further comprising a second OE assembly having a second 3D interconnect and a second integrated device, wherein the first OE assembly comprises a transmitter and the second OE assembly comprises a receiver.

5. The system of claim 1, wherein the electronic IC includes a driver and a multiplexer, and the at least one OE die comprises a vertical cavity surface emitting laser (VCSEL).

6. An apparatus comprising:
a three-dimensional (3D) interconnect having a first cavity extending into a front face thereof and a second cavity extending into a rear face thereof; and
an integrated device having an electronic integrated circuit (IC) bonded to at least one optoelectronic (OE) die, the integrated device bonded to the rear face of the 3D interconnect by corresponding bumps on the electronic IC and the 3D interconnect, the integrated device having a portion extending within the second cavity, wherein a face of an aperture portion of the at least one OE die is substantially flush with a rear wall of the first cavity.

7. The apparatus of claim 6, wherein the apparatus comprises a surface-mount opto-electrical subassembly (SMOSA).

8. The apparatus of claim 6, wherein the rear face of the 3D interconnect includes a first plurality of interconnects to be coupled to a second plurality of interconnects of a semiconductor package substrate to which the apparatus is coupled, and the electronic IC is bonded to the rear face of the 3D interconnect by a plurality of bumps of the 3D interconnect and a plurality of bumps of the electronic IC.

9. The apparatus of claim 6, further comprising a heat spreader coupled to a rear portion of the integrated device.

10. The apparatus of claim 6, further comprising a plurality of alignment holes extending from the rear face of the 3D interconnect to the first cavity.

11. The apparatus of claim 10, further comprising a plurality of alignment pins affixed within the plurality of alignment holes.

12. The apparatus of claim 6, wherein the electronic IC includes a driver and a multiplexer, and the at least one OE die comprises a vertical cavity surface emitting laser (VCSEL).
